(19) United States
(12) Patent Application Publication
(10) Pub. No.: US 2003/0085800 A1
(43) Pub. Date: May 8, 2003

(54) System and method for authenticating products

(76) Inventor: Hongbiao Li, Plano, TX (US)

Correspondence Address: Michael L. Diaz, Michael L. Diaz, P.C., Suite 200, 555 Republic Drive, Plano, TX, 75074, US

(21) Appl. No.: 09/992,369

(22) Filed: Nov. 6, 2001

(51) Int. Cl. H04B 1/00

(52) U.S. Cl. 340/5.86

(57) ABSTRACT

A method and system for determining the authenticity of a product. The system includes an interface device communicating with an authenticator. The authenticator includes a processing module and an information storage module having stored data. The interface device retrieves information from the product which is sent to the authenticator. The processing module determines if the retrieved data in combination with the stored data of the information storage module matches authenticating data stored within the processing module. If both sets of data match, the product is determined to be authentically originating from a specified manufacturer.

### BACKGROUND OF THE INVENTION

1. Technical Field of the Invention

This invention relates to product authentication systems and, more particularly, to a system and method for authenticating the origin of various products to a specific manufacturer.

2. Description of Related Art

A major problem which accounts for revenue losses totaling in billions of dollars is the counterfeiting of products. Many consumers purchase products from select manufacturers because they prefer products originating from these manufacturers. The consumer may consider that a particular manufacturer produces products of a certain quality for which the consumer desires. Oftentimes, manufacturers spend enormous amounts of money in advertising to sell their products, thus associating the name to the products. These advertisements are targeted to the consumer with the specific purpose of associating a particular product with the advertising manufacturer.

Unfortunately, goods bearing a particular mark or design are frequently copied. Many of the counterfeited goods are so like the copied manufacturer's goods that it is nearly impossible to differentiate the counterfeited product from the authenticated product. Since consumers may unsuspectingly purchase a counterfeited product from the counterfeiter, authentic manufactures lose revenue from these sales. The counterfeiters' goods not only deceive consumers, but may additionally deceive distributers and retail sellers.

Manufacturers have attempted to fight these counterfeiters by devising various ways of differentiating their products from the counterfeiters' copies. One notable method has been conducted by affixing a registered trademark to the product to designate that the goods originated from that particular manufacturer. However, counterfeiters often will merely copy the trademark. The manufacturers often try to police their mark against the authorized use. However, it is often very difficult to find all the counterfeiting manufacturers affixing their goods with the registered marks. In addition, very little can be done to stop counterfeiters from duplicating the registered trademark for use on their products, still making it impossible to differentiate the goods.

Thus, it would be a distinct advantage to have a system and method which automatically authenticates the originating manufacturer of specified products. It is an object of the present invention to provide such a system and method.

### SUMMARY OF THE INVENTION

In one aspect, the present invention is an authenticating system for determining the authenticity of a product. The system includes an authenticator having a processing module storing authenticating data. The system also includes a product having stored product data. In addition, an interface device is used for extracting the product data from the product. The interface device sends the product data to the authenticator. The processing module compares the authenticating data to the product data of the product. The authenticator determines that the product is authentic if the product data acceptably compares with the authenticating data.

In another embodiment, the present invention is a method of determining an authenticity of a product. The method starts by programming an authenticator with authenticating data used to determine the authenticity of the product. Next, product data is extracted from the product by an interface device. The product data is then transmitted to the authenticator. The authenticator compares the authenticating data with the product data extracted from the product and determines if the product data acceptably compares with the authenticating data.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for authenticating the origin of goods from a specific manufacturer in the preferred embodiment of the present invention;

FIG. 2 is a flow chart outlining the steps for authenticating a product according to the teachings of the present invention;

FIG. 3 is a simplified block diagram illustrating the components of a system for authenticating the origin of goods from a specific manufacturer in an alternate embodiment of the present invention; and

FIG. 4 is a flow chart outlining the steps for authenticating a product according to the teachings of the present invention.

### DETAILED DESCRIPTION OF EMBODIMENTS

The present invention is a system and method for authenticating the origin of goods from a specific manufacturer.

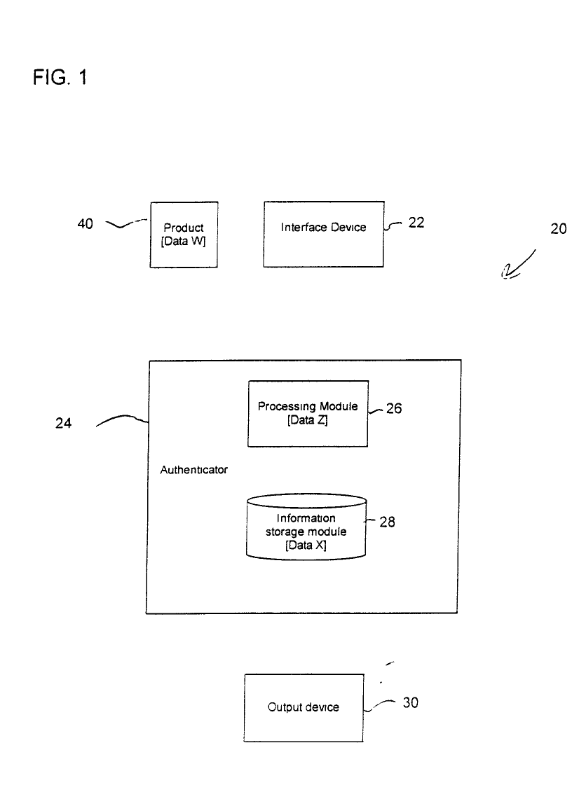

FIG. 1 is a simplified block diagram illustrating the components of a system 20 for authenticating the origin of goods from a specific manufacturer in the preferred embodiment of the present invention. The system includes an interface device 22 communicating with an authenticator 24. The authenticator 24 includes a processing module 26 and an information storage module 28. The system 20 is used to authenticate that a product 40 originates from a specific manufacturer.

The interface device 22 may be any device which retrieves necessary data W from the product 40 for processing by the authenticator 24. The interface device may be a scanner which scans bar codes or any coded display, whether visible or invisible to the naked eye. The interface device, in an alternate embodiment of the present invention, scans for a particular color within a designated area of the product, such as on an embedded tag or a label. Alternatively, the interface device may measure a specific temperature or chemical composition of a portion of the product. The portion of the product for which the interface device measures may include an encapsulated component affixed to the product. Any device may be utilized as the interface device which retrieves data W from the product 40.

The interface device transfers the retrieved data W to the authenticator 24. The interface device may be physically connected to the authenticator or communicate with the authenticator through a radio communications link. Alternatively, the authenticator may communicate with the interface device through a laser or other light emitting device (e.g., infrared light), to transfer the data.

The information storage module 28 stores confidential stored data X necessary for determining the authenticity of the product. In the preferred embodiment of the present invention, the information storage module stores a portion of the data necessary to determine the authenticity of the product. Specifically, the information storage module may store data such that the combination of the retrieved data W from the product with the stored data X may be used to determine the authenticity of the product.

In the preferred embodiment of the present invention, the processing module 26 combines the retrieved data W from the product with the stored data X. The resultant data Y is compared to confidential authenticating data Z stored within the processing module 26. If the resultant data Y matches the authenticating data Z, the product is authenticated as being from the specified manufacturer. If the resultant data Y does not match the authenticating data Z, the product is determined to be a counterfeit. The authenticator then sends the results of the determination of the authentication of the product to an output device 30. The authenticating data Z may be a range for which the resultant data Y may fall within. In such an embodiment, if the resultant data Y falls anywhere within the range, the results indicate that the product is authentic.

For example, the retrieved data W from the product 40 may be a number code. The stored data X may also be a number code. Data W is added to data X to calculate number Y. Y is compared by the processing module 26 with the authenticating data Z. Z may be an entire range of coded numbers. If resultant data Y falls within the range of numbers of authenticating data Z, the product is determined to be authentic.

In another example, the retrieved data W may be a temperature of a portion of the product 40, such as from an encapsulated component affixed to the product. The interface device 22 may be a temperature probe which measures the temperature of the interior of the encapsulated component. The temperature of the encapsulated component may be used as retrieved data W. The retrieved data W may then be combined with stored data X to calculate the resultant data Y. The resultant data Y is then compared to the authenticating data Z by the processing module 26. If the resultant data Y falls within the acceptable range of the authenticating data Z, the product is determined to be authentic. Likewise, if the data Y does not fall within the acceptable range of the authenticating data Z, the product is determined to be a counterfeit. The results are sent to the output device 30.

In still another example, the interface device 22 may scan a portion of the product (e.g., an affixed label on the products), to determine a particular color. The scanned color may be utilized as the retrieved data W. The retrieved data W is then added with the stored data X (e.g., another color). The addition of both colors results in a third color, resultant data Y. The third color, resultant data Y is compared with the authenticating color, data Z, to determine the authenticity of the product. Alternatively, the stored data X may be overlaid with the retrieved data W, both of which are colors, to create the resultant color Y.

Any characteristic of the product or an affixed label or module may be used to find a retrieved data W. In the preferred embodiment of the present invention, the retrieved data W is disguised or hidden from detection by third parties. For example, the retrieved data may be a magnetic strip having a plurality of data bits embedded within the strip. Not all the data bits are used to determine the authenticity of the product. Specific stored data bits are extracted from the magnetic strip to be used as data W. The data is stored in such a fashion that a third party would not be able to determine what data bits are extracted. In other examples, an electronic data bit stored in an electronic storage device may be used to extract specific data components for use as data W.

The data W may be stored within the product in various forms. For example, the data W may be stored electronically within an electronic storage device affixed directly to the product or its package. In another example, the data may be stored on a magnetic strip, a liquid emitting diode readout code, a bar code, a chemical stored within a particular location on the product, a stored musical code, the specific content of moisture within a stored component of the product, a laser emitting device, a temperature within a component of the product, a specific range of low radioactive material, or any other device which may be used to store data within the product or its packaging.

The interface device 22 may extract the data W through various methods to obtain different types of data as discussed above. In addition, the interface device may be capable of extracting a plurality of different types of data from the product. In the preferred embodiment, the correct information required to be extracted from the product to constitute the data W is unknown except from the manufacturer.

The type of data extracted may also be protected from unauthorized use by providing a destruction device which destroys relevant data within the interior of the interface device, such as when the interface device is incorrectly opened. Specifically, only authorized personnel may know the correct procedure for opening the interface device to access the interior of the interface device without damaging the stored data. Various devices are currently available to provide security against the unauthorized access to the interior of a device. Such devices may be easily incorporated within the interface device. Additionally, similar devices may be used to protect against unauthorized entry within the authenticator.

Additionally, the stored data X may be anything which may be used to combine with the retrieved data W to calculate a resultant data Y. The stored data X does not necessarily have to be the same type of data as the retrieved data W. For example, the retrieved data W may be a scent retrieved from a module affixed to the product 40. The scent may be combined with a chemical agent acting as data X, stored within the information storage module 28. The chemical reaction resulting from the scent and the chemical agent may produce another chemical, data Y.

The output device may be a visual or aural display. For example, the output device may display a green light to indicate that the product is authentic or a red light to indicate the product is a counterfeit. In another example, the output device may emit a high-pitched sound to indicate the authenticity of the product.

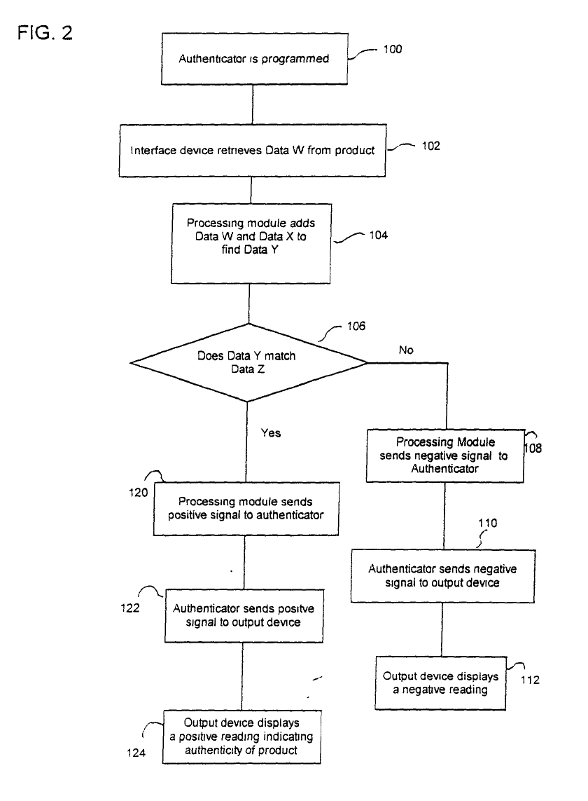

FIG. 2 is a flow chart outlining the steps for authenticating a product 40 according to the teachings of the present invention. With reference to FIGS. 1, 2A and 2B, the steps of the method will now be explained. The method begins with step 100 where the authenticator 24 is programmed to authenticate a product from a specific manufacturer. The information storage module 28 stores stored data X relating to the manufacturer. As discussed above, the stored data X may be any data relevant for determining the authenticity of the product. For example, a specific code, characteristic, number, color, or temperature may be stored within the stored data X. In addition to providing data X to the information storage module, the processing module 26 is programmed with the authenticating data Z. As discussed above, the data Z is the data used to compare with the resultant data Y. The data Z may be a specific number, code, characteristics, etc. providing the ability to authenticate the data Y. In addition, in conjunction with the programming of the authenticator, the interface device may also be programmed to specify the particular data necessary to retrieve the data W.

Next, in step 102, the interface device 22 retrieves the retrieved data W from the product 40. The interface device may be any device to retrieve the data W, such as a scanner or a temperature probe. The method then moves to step 104 where the stored data X of the information storage module 28 and the retrieved data W retrieved by the interface device from the product 40 is added together by the processing module to find the resultant data Y.

In step 106, it is determined by the processing module 26 if the resultant data Y matches the authenticating data Z. The processing module may authenticate the data Y if the data falls within a range or specific identifying characteristics stored in data Z. If the processing module determines that the data Y is not within the designated range of the data Z, the method moves to step 108 where the processing module sends a negative signal indicating that the data Y does not fall within the acceptable range of data Z to the authenticator. Next, in step 110, the authenticator optionally sends a negative result signal to the output device 30. In an alternate embodiment of the present invention, the authenticator does not send any signal to the output device 30 if the results are negative in regards to the authenticity of product 40. Next, in step 112, the output device 30 displays a negative reading, either visually or aurally. For example, the output device may emit a red light to indicate that the product is not authentic. In another example, the output device may transmit an aural beep indicating that the product is not authentic.

However, if it is determined by the processing module determines that the data Y is not within the designated range of the data Z, the method moves from step 106 to step 120 where the processing module sends a positive signal to the authenticator indicating that the data Y falls within the acceptable range of data Z. Next, in step 122, the authenticator optionally sends a positive signal to the output device 30. In an alternate embodiment of the present invention, the authenticator does not send any signal to the output device 30 if the results are positive that the product 40 is authentic. Next, in step 124, the output device 30 displays a positive reading, either visually or aurally. For example, the output device may emit a green light to indicate that the product is authentic. In another example, the output device may transmit an aural beep indicating that the product is authentic.

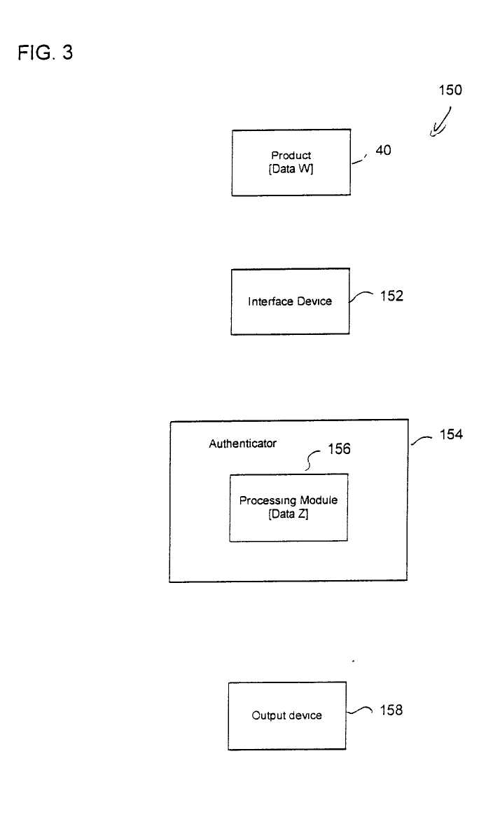

FIG. 3 is a simplified block diagram illustrating the components of a system 150 for authenticating the origin of goods from a specific manufacturer in an alternate embodiment of the present invention. The system includes an interface device 152 communicating with an authenticator 154. The authenticator 24 includes a processing module 156. In addition, the system 150 includes an output device 158. With a similar purpose as system 20, system 150 is used to authenticate that a product 40 originates from a specific manufacturer. The system 150 differs from the system 20 in that retrieved data W is compared with authenticating data Z within reference or combination with stored data X. However, all other embodiments discussed with system 20 may also apply to system 150.

The interface device 152 is similar as interface device 22 in that the device may be any device which retrieves data W from the product 40 for processing by the authenticator 154. The interface device may be a scanner, a probe, a measuring device or any other device which may extract data from the product 40. For example, the interface device may scan for a particular color within a designated area of the product, such as on an embedded tag or a label. In another embodiment, the interface device may measure a specific temperature or chemical composition of a portion of the product. The portion of the product for which the interface device measures may include a segregated component affixed to the product.

As discussed for system 20, any characteristic of the product or an affixed label or module may be used to find a retrieved data W. Preferably, the retrieved data W is disguised or hidden from determination by third parties. Thus, specific data W stored within the product 40 may be mixed with other extraneous data to prevent the determination of the actual data W. In other embodiments, the data W is hidden from view and capable of being extracted by the interface device. A third party would not be able to determine what data bits are extracted. In other examples, an electronic data bit stored in an electronic storage device may be used to extract specific data components for use as data W.

The data W may be stored within the product in various forms. For example, the data W may be stored electronically within an electronic storage device affixed directly to the product or its package. In another example, the data may be stored through a magnetic strip, a liquid emitting diode readout code, a bar code, a chemical stored within a particular location on the product, a stored musical code, the specific content of moisture within a stored component of the product, a laser emitting device, a temperature within a component of the product, a specific range of low radioactive material, or any other characteristics which may be used to store data within the product or its packaging.

In addition, the interface device 152 may extract the data W through various methods to obtain different types of data as discussed above. In addition, the interface device may be capable of extracting a plurality of different types of data from the product. In the preferred embodiment, the correct Information required to be extracted from the product to constitute the data W is unknown except by the manufacturer.

The interface device 152 transfers the retrieved data W to the authenticator 154. The interface device may be physically connected to the authenticator, communicate with the authenticator through a radio communications link, or through a laser or other light spectrum device (e.g., infrared light), to transfer the data.

The processing module stores authenticating data Z used for determining the authenticity of product 40. The authenticating data Z may be a range for which the retrieved data W may fall within. Thus, if the retrieved data W falls anywhere within the acceptable range, the results indicate that the product is authentic. The authenticating data Z is preferably stored in a manner which cannot be extracted from the processing module. Such storage methods are well known within the art of computer processors.

The retrieved data W is compared by the processing module 156 with the authenticating data Z. Data Z may provide an acceptable range for which data W may fall within and indicate a positive indication of the authenticity of the product. In another embodiment of the present invention, the data Z may only provide a specific and distinct characteristic for which data W must exactly match to positively indicate the authenticity of the product 40.

To exemplify the system 150, the retrieved data W may be a number code extracted from the product 40. The authenticating data Z may also be a number code. The processing module 156 may compare a portion or all of the number code of data X with the authenticating data Z. If the data W falls within the acceptable range specified within data Z, the processing module determines that the product 40 is authentic. The portion of data W may be disguised in such a fashion that counterfeiters cannot determine the appropriate authenticating data. For example, a number code may only include a portion of a code which is acceptable, while other parts of the number code are extraneous.

In another example, the retrieved data W may be a temperature of a portion of the product 40, such as from an encapsulated component affixed to the product. The interface device 156 may be a temperature probe which measures the temperature of the interior of the encapsulated component. The temperature of the encapsulated component may be used as retrieved data W. The retrieved data W may then be compared with a temperature range or specific temperature stored within the processing module 156. If the retrieved data W falls within the acceptable range of the authenticating data Z, the product is determined to be authentic. Likewise, if the data W does not fall within the acceptable range of the authenticating data Z, the product is determined to be a counterfeit. The results are sent to the output device 30.

In still another example, the interface device 156 may be a scanning device extracting a hidden color or code from the product, such as an ultraviolet light which illuminates a hidden code. The data W may then be extracted from the product 40 and compared by the processing module 156 to the data Z.

As with system 20, any characteristic of the product or an affixed label or module may be used to find a retrieved data W. In addition, the output device 158 may be a visual or aural display. For example, the output device may display a green light to indicate that the product is authentic or a red light to indicate the product is a counterfeit. In another example, the output device may emit a high-pitched sound to indicate the authenticity of the product. In addition, as with the system 20, the system 150 may incorporate a destruction device to prevent the unauthorized entry within the authenticator and the interface device.

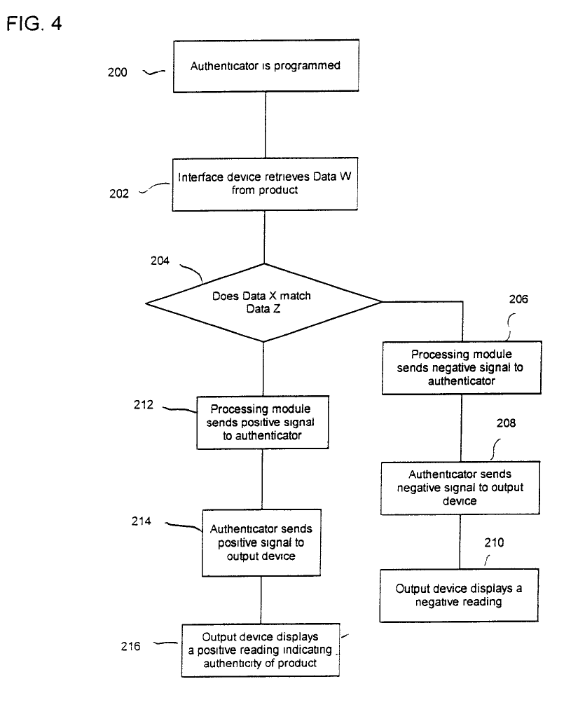

FIG. 4 is a flow chart outlining the steps for authenticating a product 40 according to the teachings of the present invention. With reference to FIGS. 4, 3A and 3B, the steps of the method will now be explained. The method begins with step 200 where the authenticator 154 is programmed to authenticate a product from a specific manufacturer. The processing module 156 located within the authenticator stores authenticating data Z relating to the manufacturer. As discussed above, the authenticating data Z may be any data relevant for determining the authenticity of the product. For example, a specific code, characteristic, number, color, or temperature may be stored within the data Z. In addition to storing data Z, the processing module is programmed to compare the data Z with the retrieved data W within a specified range (or distinct value). As discussed above, the authenticating data may be secured in such a fashion that if the authenticating data is incorrectly accessed, that the authenticating data is erased or destroyed.

Next, in step 202, the interface device 152 retrieves the retrieved data W from the product 40. The interface device may be any device to retrieve the data W, such as a scanner or a temperature probe. The method then moves to step 204 where it is determined by the processing module 156 if the retrieved data X falls within the acceptable range of the authenticating data Z. If the processing module determines that the data W is not within the designated range of the data Z, the method moves to step 206 where the processing module sends a negative signal indicating that the data W does not fall within the acceptable range of data Z to the authenticator. Next, in step 208, the authenticator optionally sends a negative result signal to the output device 158. In an alternate embodiment of the present invention, the authenticator does not send any signal to the output device if the results are negative that the product 40 is authentic. Next, in step 210, the output device displays a negative reading, either visually or aurally. For example, the output device may emit a red light to indicate that the product is not authentic. In another example, the output device may transmit an aural beep indicating that the product is not authentic.

However, if it is determined by the processing module determines that the data W is within the designated range of the data Z, the method moves from step 204 to step 220 where the processing module sends a positive signal to the authenticator indicating that the data W falls within the acceptable range of data Z. Next, in step 222, the authenticator optionally sends a positive signal to the output device. In an alternate embodiment of the present invention, the authenticator does not send any signal to the output device if the results are positive that the product 40 is authentic. Next, in step 224, the output device displays a positive reading, either visually or aurally. For example, the output device may emit a green light to indicate that the product is authentic. In another example, the output device may transmit an aural beep indicating that the product is authentic.

The systems and methods of the disclosed invention provide many advantages over existing authenticating systems. The disclosed invention provides an efficient and effective way for a party to ascertain the authenticity of a product. With existing means of determining the authenticity, a party was limited by looking at the actual product or an affixed label to determine the authenticity of the product. With the disclosed invention, a party may easily determine the authenticity by extracting the data necessary to authenticate the product. In addition, the disclosed invention enables the authenticating data to be hidden from counterfeiters. The interface device may extract a large amount of data for which only a portion may be utilized by the authenticator to compare with the authenticating data Z. Therefore, it is extremely difficult for a counterfeiter to copy the product with the necessary data W without knowledge of what the relevant data W is required.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. An authenticating system for determining the authenticity of a product, said system comprising:
an authenticator having a processing module storing authenticating data;
a product having stored product data;
an interface device for extracting the product data from the product, said interface device sending the product data to said authenticator;
said processing module comparing the authenticating data to the product data of said product;
whereby said authenticator determines that the product is authentic if the product data acceptably compares with the authenticating data.

2. The authenticating system of claim 1 wherein the product data is concealed within said product.

3. The authenticating system of claim 2 wherein the product data is concealed by providing extraneous data with the product data.

4. The authenticating system of claim 1 wherein said interface device may extract a plurality of different types of data from said product.

5. The authenticating system of claim 1 wherein the product data acceptably compares with the authenticating data by comparing a range for which the product data may fall within.

6. The authenticating system of claim 1 wherein the product data acceptably compares with the authenticating data by comparing a distinct value for which the product data must attain.

7. The authenticating system of claim 1 wherein:
said authenticator has an information storage module storing supplemental data;
said supplemental data being used in conjunction with the product data to compare with the authenticating data.

8. The authenticating system of claim 1 wherein said authenticator emits a visual signal to indicate that the product data acceptably compares with the authenticating data.

9. The authenticating system of claim 1 wherein said authenticator emits an aural signal to indicate that the product data acceptably compares with the authenticating data.

10. The authenticating system of claim 1 wherein said authenticator emits a signal to indicate that the product data does not acceptably compare with the authenticating data.

11. The authenticating system of claim 1 wherein the authenticator includes means to destroy the authenticating data if the authenticator is opened incorrectly.

12. A method of determining an authenticity of a product, said method comprising the steps of:
programming an authenticator with authenticating data used to determine the authenticity of the product;
extracting product data from the product by an interface device;
transmitting the product data to the authenticator;
comparing, by the authenticator, the authenticating data with the product data extracted from the product;
determining, by the authenticator, if the product data acceptably compares with the authenticating data.

13. The method of determining an authenticity of a product of claim 12 wherein the step of programming an authenticator includes storing supplementary data within the authenticator, said supplementary data being added with the product data to compare with the authenticating data.

14. The method of determining an authenticity of a product of claim 12 further comprising, after the step of determining, by the authenticator, if the product data acceptably compares with the authenticating data, the step of sending a signal to indicator the authenticity of the product.

15. The method of determining an authenticity of a product of claim 12 wherein the step of determining, by the authenticator, if the product data acceptably compares with the authenticating data includes determining if the product data falls within a specific range of values of authenticating data.

16. The method of determining an authenticity of a product of claim 12 wherein the authenticating data is a distinct value.

17. The method of determining an authenticity of a product of claim 12 further comprising, before the step of programming an authenticator, the step of concealing product data within the product.

18. The method of determining an authenticity of a product of claim 17 where in the step of concealing product data includes providing extraneous data to conceal the product data.

19. The method of determining an authenticity of a product of claim 12 further comprising, after the step of programming an authenticator, the step of destroying the authenticating data if the authenticator is incorrectly opened.
